(19) United States
(12) Patent Application Publication
(10) Pub. No.: US 2014/0041757 A1
(43) Pub. Date: Feb. 13, 2014

(54) COLLAPSIBLE FUNNEL

(71) Applicant: Van M. Kassouni, Grand Rapids, MI (US)

(72) Inventor: Van M. Kassouni, Grand Rapids, MI (US)

(21) Appl. No.: 13/960,258

(22) Filed: Aug. 6, 2013

Related U.S. Application Data
(60) Provisional application No. 61/738,557, filed on Dec. 18, 2012.
(60) Provisional application No. 61/680,502, filed on Aug. 7, 2012.

(51) Int. Cl. B67C 11/02

(52) U.S. Cl. CPC B67C 11/02
USPC 141/337

(57) ABSTRACT

A funnel assembly includes a plurality of legs and a funnel element having a larger opening and a smaller opening. The funnel element is attached at the legs and is collapsible and expandable between a use state, where the larger opening is substantially opened and the legs are arranged to support the funnel assembly in a free-standing manner, and a collapsed state, where the funnel and the legs are collapsed for storage. When in the use state, the funnel assembly may be disposed at a floor or support surface and the larger opening is at an upper region of the funnel assembly and the smaller opening is at a lower region of the funnel and spaced from the floor or support surface.

### CROSS REFERENCE TO RELATED APPLICATIONS

The present application is related to U.S. provisional applications, Ser. No. 61/738,557, filed Dec. 18, 2012, and Ser. No. 61/680,502, filed Aug. 7, 2012, which are hereby incorporated herein by reference in their entireties.

### FIELD OF THE INVENTION

The present invention relates generally to devices for collecting water or other fluids and, more particularly, to a device or system for collecting water that drips from an overhead structure, such as a ceiling or roof or conduit of a building.

### BACKGROUND OF THE INVENTION

When a ceiling or roof leaks, such as during a rain storm or as snow on the roof melts, water falls from the ceiling onto the floor, and sometimes in an area where people may walk. In such situations, it is known to place buckets at those areas to try to capture or catch the falling water. Because the bucket often fails to provide a large enough opening to catch the dripping water, water tends to drip or splash onto and accumulate on the floor, whereby a sign may be posted at or near the bucket to alert people passing by of the leaking ceiling and of the potential for a wet or slippery floor. In situations where a very large container is used to provide a larger opening for catching water, the very large container may be difficult to move as it becomes full of water.

### SUMMARY OF THE INVENTION

The present invention provides a system for collecting leaking fluid or water that includes a funnel device or assembly that is positionable at a leaking area to collect and direct falling water or fluid that is dripping from an overhead structure into a container or bucket or the like. The funnel device is a collapsible device or apparatus that, when in its expanded or non-collapsed state, the funnel is free-standing and does not require a user to hold it in position at the container. The funnel, when in its expanded state, has a larger receiving opening at its upper end with walls that taper or converge to an opening at its lower end that is smaller than an opening of a container placed under the funnel. The collapsible funnel device may have three or more legs that may fold (or the funnel device may otherwise be adjustable between its collapsed and non-collapsed states, such as via a coiled spring type configuration or the like) and the funnel walls may fold or collapse to collapse the funnel to a collapsed state for easy carrying and storage of the funnel when not in use.

Thus, the present invention provides a funnel system with a funnel device or assembly that is collapsible for storage and expandable to a use position for free-standing use in collecting and directing water or other fluid (such as water dripping from a leak in a ceiling or roof or pipe or conduit of a building) into a container that is placed at least partially beneath the funnel. The funnel device thus may be readily set up at a leaking area and limit the dripping of water onto a floor, where the water may make the floor wet and slippery. The funnel device may be readily collapsed for easy storage when not in use.

These and other objects, advantages, purposes and features of the present invention will become more apparent upon review of the following specification in conjunction with the drawings.

### BRIEF DESCRIPTION OF THE DRAWINGS

FIG. 1 is a perspective view of a funnel device in accordance with the present invention, shown in its expanded or use state;

FIG. 2 is an upper perspective view of the funnel device of FIG. 1;

FIG. 3 is an underside perspective view of the funnel device of FIGS. 1 and 2;

FIG. 4 is a side elevation of the funnel device of FIGS. 1-3;

FIG. 5 is a top plan view of the funnel device of FIGS. 1-3;

FIG. 6 is a bottom plan view of the funnel device of FIGS. 1-3;

FIG. 7 is a sectional view of the funnel device of FIGS. 1-3;

FIG. 8 is a perspective and partial sectional view of another funnel device in accordance with the present invention, shown in its expanded or use state;

FIG. 9 is a perspective view of the funnel device of FIG. 8, shown in its collapsed or non-use state;

FIG. 10 is a perspective view of another funnel device in accordance with the present invention, shown in its expanded or use state;

FIG. 11 is a side elevation of the funnel device of FIG. 10;

FIG. 12 is an end elevation of the funnel device of FIG. 10;

FIG. 13 is a top plan view of the funnel device of FIG. 10;

FIGS. 14-17 are perspective view of the adjustable connectors of the funnel device of FIG. 10;

FIG. 18 is a side elevation of an adjustable connector;

FIG. 19 is a perspective view of one part of the adjustable connector;

FIGS. 20-22 are other views of the part of the adjustable connector of FIG. 19; and

FIGS. 23-25 are views of one of the fixed 90 degree connectors of the funnel device of FIG. 10.

### DESCRIPTION OF THE PREFERRED EMBODIMENTS

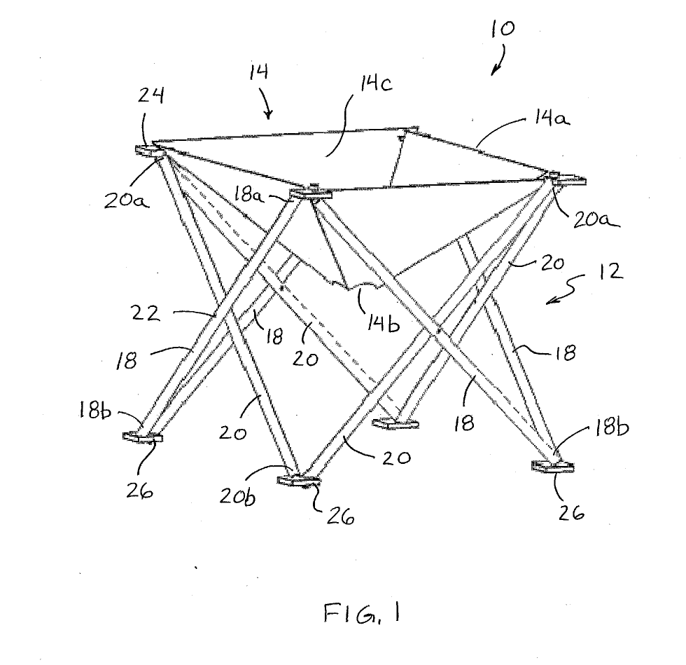

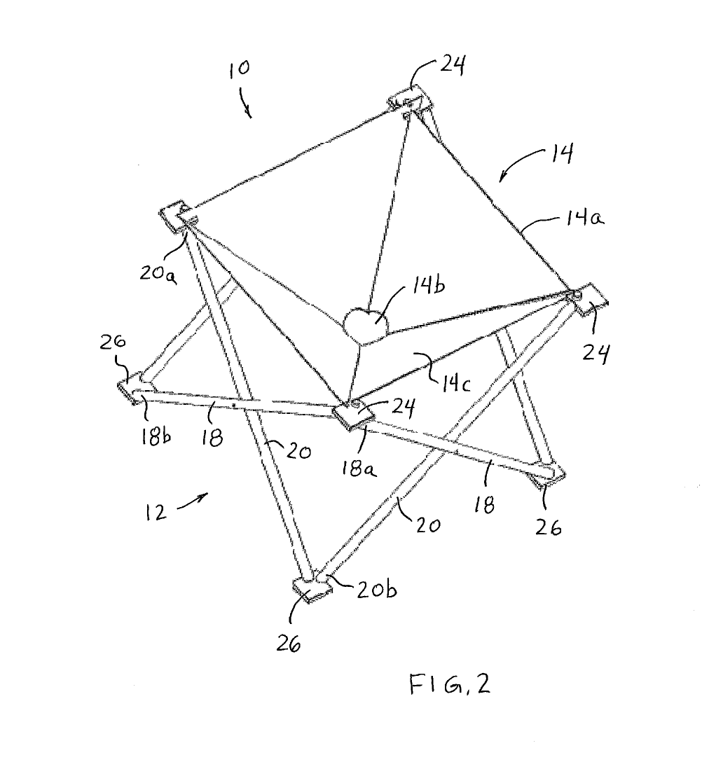

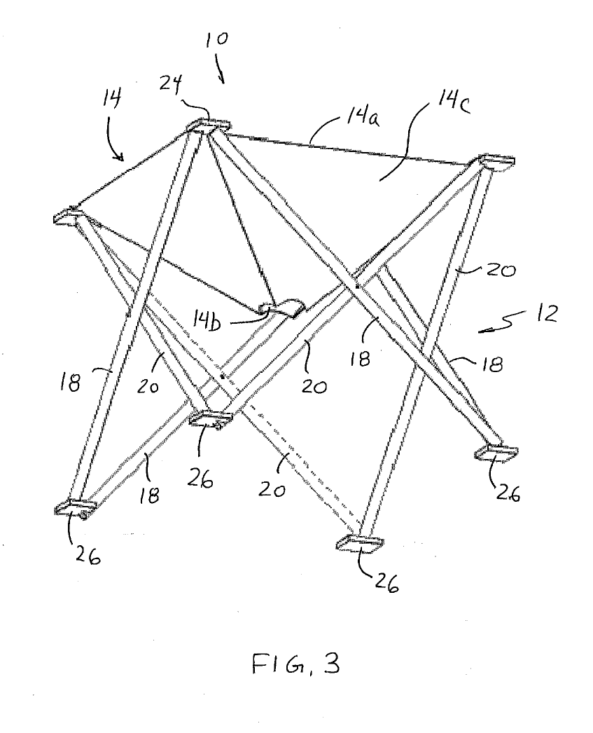

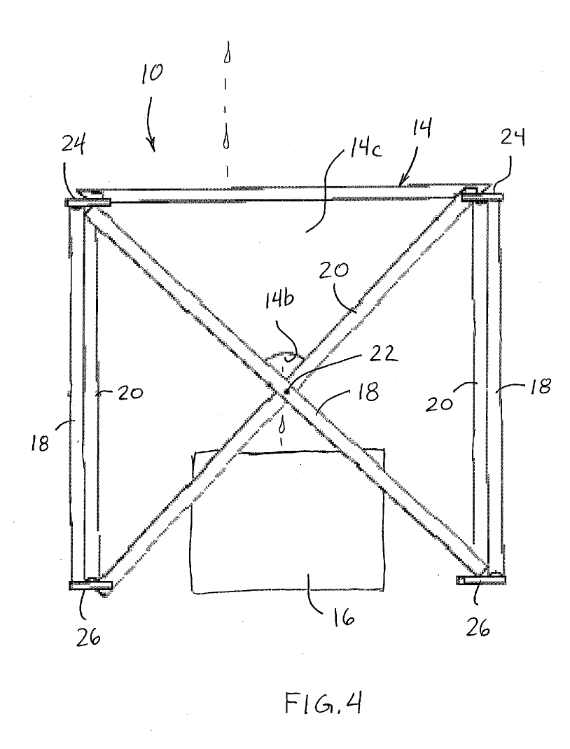

Referring now to the drawings and the illustrative embodiments depicted therein, a funnel device or apparatus or assembly 10 includes a collapsible support structure 12 and a funnel 14 that are collapsible and uncollapsible or foldable between a collapsed state, where the funnel device is collapsed for storage when not in use, and a use or expanded state, where the funnel device is expanded to a free-standing configuration for use (FIGS. 1-7). The funnel device 10, when in its use state, provides a funnel 14 that has a larger sized or larger diameter opening at its upper end 14a and a smaller sized or smaller diameter opening 14b at its lower end so that the upper end 14a receives or collects water and the walls 14c of the funnel direct the water to the lower end opening 14b, whereby the water may flow into a container 16 (FIG. 4) or the like, as discussed below.

In the illustrated embodiment, the collapsible support structure comprises a plurality of legs (such as three or more legs). As shown in FIGS. 1-7, the legs 12 comprise scissor-type legs 18, 20 at each side of the funnel 14. The legs 18, 20 are pivotally connected together via a pivot pin 22 at a generally center region of the legs, with legs 18 disposed outboard of legs 20. The legs have upper ends 18a, 20a that are pivotally mounted at respective support elements 24 at respective upper corners or regions of the upper end 14a of the funnel 14 and that have lower ends 18b, 20b that are pivotally mounted at respective feet or support pads 26. Thus, the legs may pivot about pivot pins 22 and relative to support elements 24 and support pads 26 to expand to their generally X-shaped open or expanded configuration (FIGS. 1-6), whereby the funnel 14 is opened via the upper ends of the legs pulling at the respective corner regions of the funnel, and to collapse to a collapsed state or configuration, where the legs 18, 20 may be generally parallel to one another and with the respective corners of the funnel being generally drawn or urged together to collapse the funnel. The legs 18, 20 may comprise any suitable material, such as a metallic material or a plastic or polymeric material or the like. Optionally, one or more of the legs may be fixedly attached at a respective support element 24 and/or support pad or foot 26 (such that the element 24, 26 is disposed at an appropriate angle relative to the leg or legs so as to be generally horizontal when the funnel device is in its expanded or use state), while remaining within the spirit and scope of the present invention.

The support elements 24 are attached via any suitable attachment means at respective corners or regions of the upper end 14a of the funnel 14. Funnel 14 may comprise any suitable material, such as a flexible material, such as a fabric or plastic sheet material or the like, which may flex and/or fold as the funnel device 10 is collapsed to its non-use or storage state. When the funnel device 10 is unfolded to its use state, the upper end 14a of the funnel 14 may be generally taut between the support elements 24 so that the funnel 14 is held wide open to provide a large receiving area for receiving water that is dripping or flowing or falling from the leak in the overhead structure or ceiling or roof (or leaking pipe or conduit or the like). The funnel 14 may provide a four-sided funnel (such as shown) that has walls 14c that are tapered so that the walls taper or converge towards the lower end of the funnel, where the opening 14b is established for water to flow from the funnel and into the container 16. Optionally, a nozzle or tube may be provided at the opening 14b of the funnel, such that the tube may be at least partially received in the container 16 to further limit or substantially preclude splashing or dripping of water onto the floor or support surface.

In the illustrated embodiment, the walls 14c of the funnel 14 are generally uniform so that the opening 14b is generally centrally located at the lower region of the funnel and at a generally central region of the funnel device. Optionally, the walls 14c of the funnel 14 may be otherwise shaped and the lower opening of the funnel may be otherwise disposed or established (such as towards one side or another of the funnel device), while remaining within the spirit and scope of the present invention. For example, the lower opening may be towards one side of the funnel (which may be square or rectangular or any other shape) and funnel device so that a container may be readily disposed beneath the lower opening of the funnel device at or near a side region of the device (such that a person does not have to reach under the funnel device to position the container at a generally central region of the funnel device). Optionally, the funnel material may comprise a semi-rigid material, such as a plastic or polymeric material, and may have folding seams or the like (such as living hinge type seams) so that the funnel may readily fold along multiple seams or fold lines when the funnel device is collapsed.

In the illustrated embodiment, the legs 12 of the funnel device comprise four sets of pivotally connected legs and the funnel 14 comprises a four-sided funnel. However, the funnel device may include three sets of pivotally connected legs or five or more sets of pivotally connecting legs and the funnel may comprise any other suitable shape or form, while remaining within the spirit and scope of the present invention. Optionally, the funnel device may only have three or more individual legs with stabilizing elements that span between the legs when the funnel device is expanded to stabilize the legs and the funnel device at a support surface and at a container when in its expanded or use state.

The container may comprise any suitable container, such as a bucket or the like, and may be placed on the floor or support surface beneath the funnel so that water flowing from the lower opening of the funnel flows into an opening or mouth of the container. The mouth or opening of the container is sized to be larger than the lower funnel opening, so that the water collected and directed or channeled by the funnel is received in the container. For example, the width or cross dimension of the upper end of the funnel may be at least about 18 inches, and preferably at least about 24 inches, while the container may have an opening of around 12 inches or less (such as a standard sized bucket or pail), with the lower opening of the funnel being the same size or smaller than the container opening.

Optionally, the container may be detachably attached at the funnel device so that the opening of the funnel is generally fixed relative to the opening of the container, so that movement of the funnel device also moves the container. The container may be readily detached from the funnel device for emptying of the container when it is filled or substantially filled. Optionally, a hose or drainage conduit may be attached at the lower opening of the funnel (which may have a threaded male or female hose connector established thereat) so as to drain the collected water or fluid to another location.

Optionally, the funnel device may be colored, such as brightly colored, such as a yellow color or an orange or red color or the like, to enhance the visibility of the funnel device so as to warn people of the leak and of a potentially wet and slippery floor condition. The funnel device may include warning language or text printed thereon (such as screen printed on the exterior surfaces of the funnel walls or the like) to alert people as to the presence of a leak in the ceiling or floor or conduit and/or as to the presence of a potentially wet and slippery floor condition. For example, a flap or panel may extend from or attach to the upper end of the funnel at the side or sides of the funnel (for example, the flap may be an extension of the funnel material and integrally formed with the funnel), so that the flap (such as with colored text and/or indicia printed thereon) hangs down from the upper end of the funnel and is readily viewable and discernible and readable by a person approaching the funnel assembly when the funnel assembly is in use.

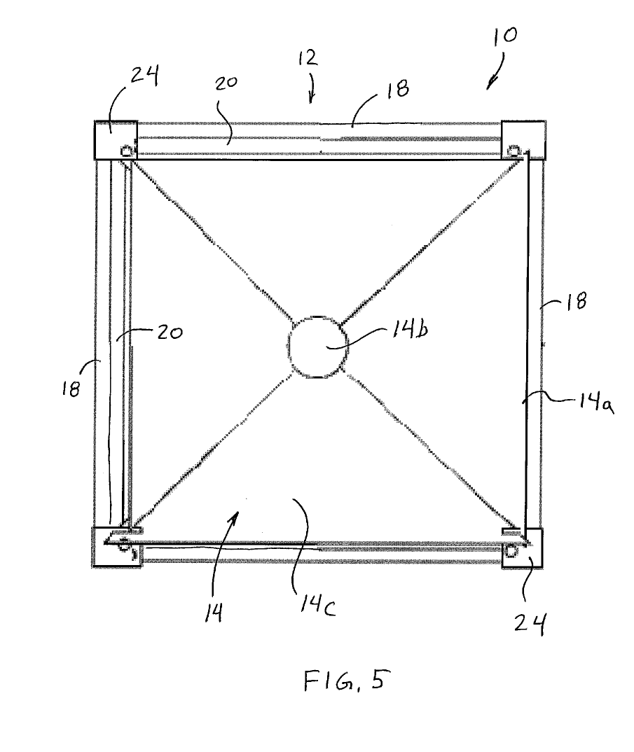

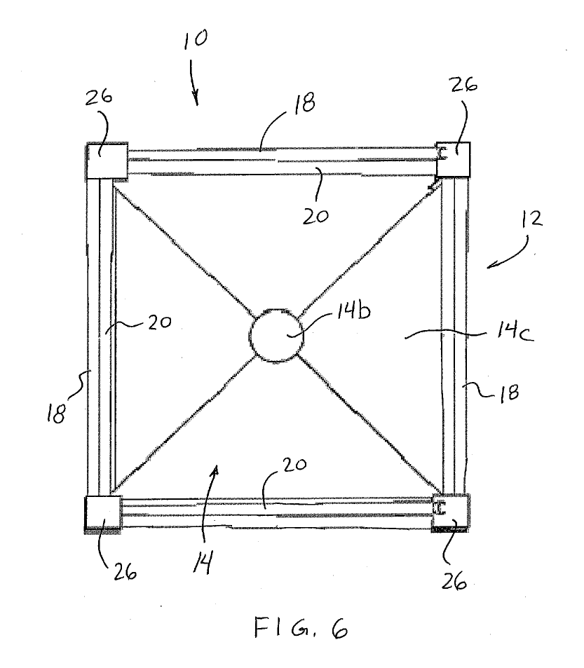

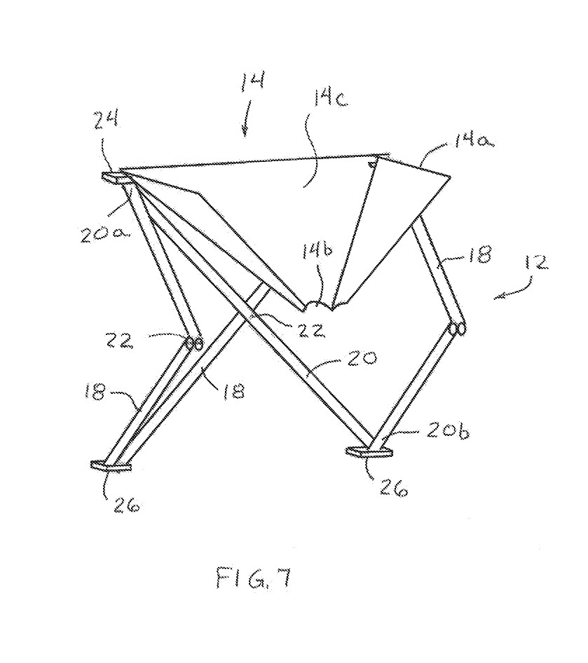

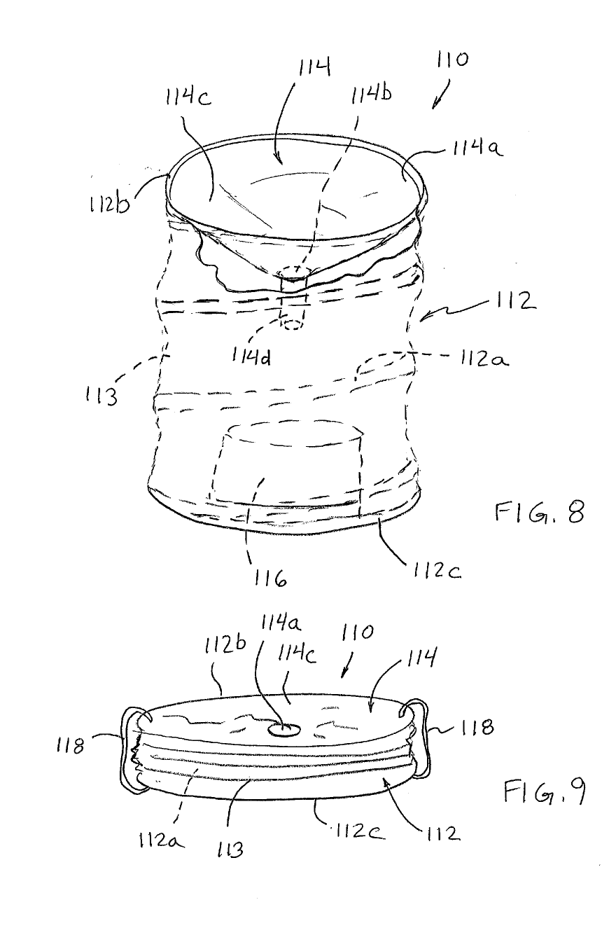

Optionally, other means for providing a collapsible funnel system or device that, when collapsed to a non-use state, is readily stored and, when uncollapsed to a use state, is readily placed at or over a collecting container to funnel water or fluid leading from a ceiling or structure or the like into the container. For example, and with reference to FIGS. 8 and 9, a funnel device or apparatus or assembly 110 includes a collapsible support structure 112 and a funnel 114 that are collapsible and uncollapsible between a collapsed state, where the funnel device is collapsed for storage when not in use, and a use or expanded state, where the funnel device is expanded to a free-standing configuration for use. The funnel device 110, when in its use state, provides a funnel 114 that has a larger sized or larger diameter opening at its upper end 114a and a smaller sized or smaller diameter opening 114b at its lower end so that the upper end 114a receives or collects water and the walls 114c of the funnel direct the water to the lower end opening 114b, whereby the water may flow into a container 116 (FIG. 8) or the like.

In the illustrated embodiment of FIGS. 8 and 9, the support structure 112 comprises a coiled spring-type structure, whereby one or more elements 112a are coiled to form a generally cylindrical support structure, with the coiled elements 112a forming a circular ring 112b at the upper end of the support structure and forming at least a partial circular ring 112c at a lower or base end of the support structure. The support structure 112 may include a flexible fabric (or other material) shell 113 that surrounds the coiled elements 112a to provide sidewalls to the support structure when in its use state. The shell 113 also functions to at least partially or substantially or entirely conceal the container 116 from view to a person viewing the funnel device 110 when it is in use.

The funnel 114 may comprise a fabric material that may flex and unfold to its use state when the support structure is expanded. As shown in FIG. 8, when the funnel device 110 is in use, the funnel 114 may unfold or uncollapse or expand or may stretch so that the walls 114c of the funnel 114 extend downwardly and radially inwardly from the upper ring 112b to collect and guide water or fluid towards the drain hole or opening 114b (and optionally into a tube or further water guide or passageway 114d) to guide and drain the water or fluid into the container 116. The funnel 114 may comprise any suitable material and/or structure, and may comprise a flexible fabric material that is formed in the funnel shape shown in FIG. 8, but readily collapses when the funnel device 110 is collapsed as shown in FIG. 9. Optionally, the funnel 114 may include a plurality of generally radially disposed ribs to provide enhanced rigidity and support of the funnel during use of the funnel device. Optionally, the funnel may comprise a plurality of generally triangular-shaped plates or elements that are attached at their wider end at the upper ring 112b and that may pivot downward towards the use state whereby the edges of the plates overlap one another or join with one another to provide the generally funnel-shaped configuration of the funnel when in use.

Thus, the funnel device may be collapsed to its non-use state for storage, and may be secured or retained in its collapsed state, such as via clasping or tying the upper and lower rings 112b, 112c generally together (such as via one or more clasps or clips or retaining elements 118) to limit or avoid separation of the rings and extension of the coiled elements 112a (such that the collapsed funnel device is a generally flat or disc-shaped structure). The funnel device may be readily expanded to its use state, and may be biased towards its expanded state, such that when the funnel device is released from its non-use collapsed state (such as via untying or unclasping the upper and lower rings), the coiled element or elements extend to form the generally cylindrical funnel structure (with the coiled element or elements forming a generally helical-shaped or coiled spring-shaped configuration when extended or uncollapsed). The lower ring or base 112c is open so that the funnel device may, when in its use state, be set over a container 116 and disposed at or under a leading overhead structure, whereby water or fluid leaking from the overhead structure may drop onto the funnel portion 114 and may be guided down to the drain opening 114b of the funnel and into the container 116.

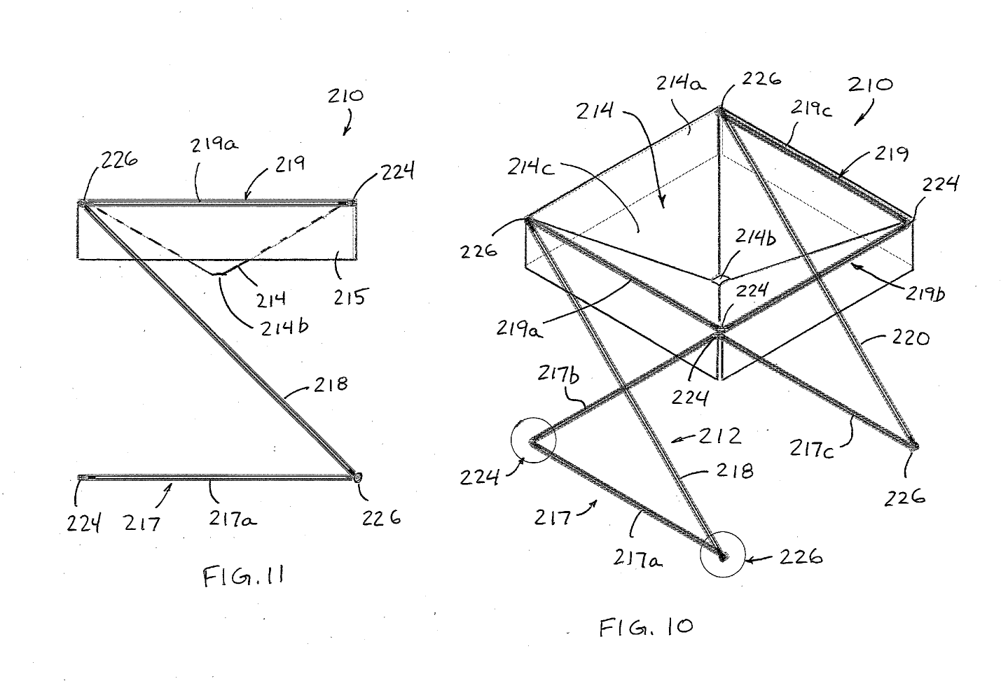

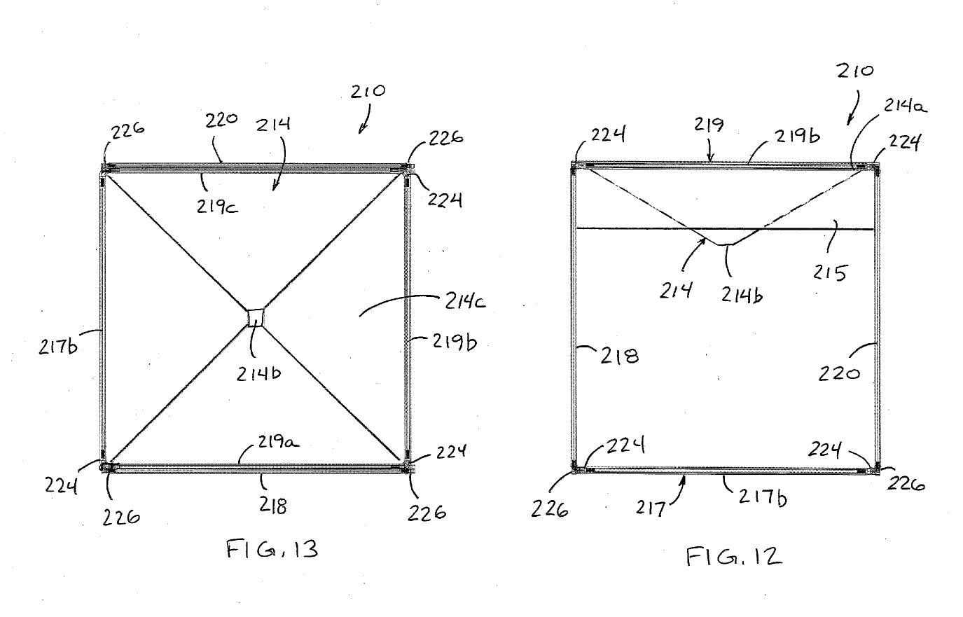

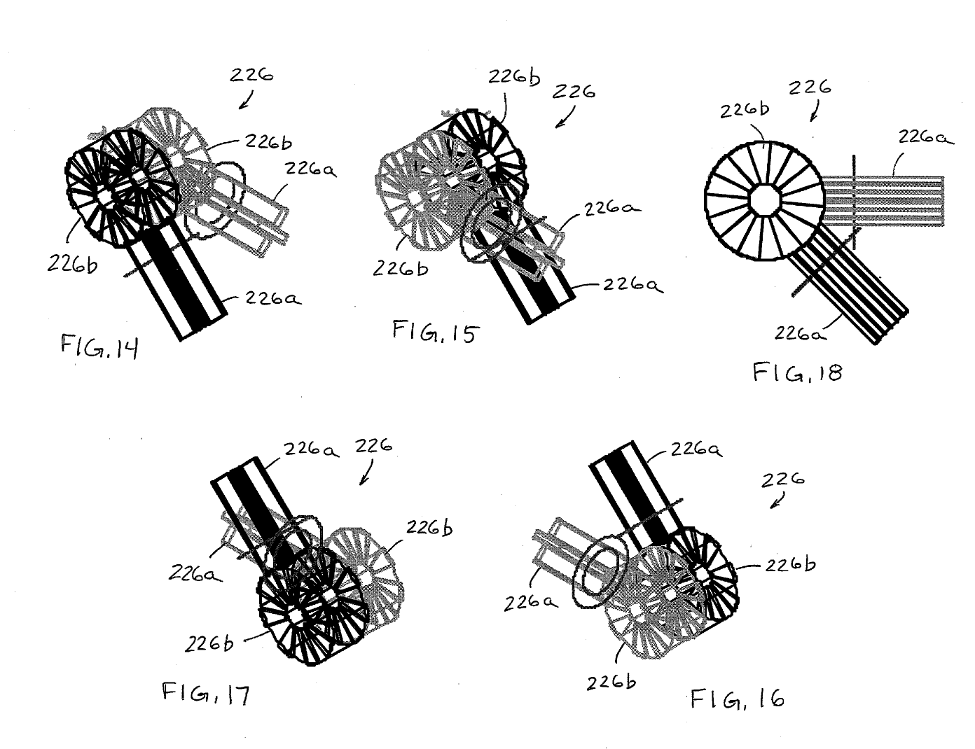

Optionally, the funnel device may comprise any other suitable collapsible and expandable construction that allows for collapsing the funnel device for storage and expanding the funnel device for use. For example, and with reference to FIGS. 10-13, a funnel device 210 includes a collapsible support structure 212 and a funnel 214 that are collapsible and uncollapsible or foldable between a collapsed state, where the funnel device is collapsed for storage when not in use, and a use or expanded state, where the funnel device is expanded to a free-standing configuration for use. The funnel device 210, when in its use state, provides a funnel 214 that has a larger sized or larger diameter opening at its upper end 214a and a smaller sized or smaller diameter opening 214b at its lower end so that the upper end 214a receives or collects water and the walls 214c of the funnel direct the water to the lower end opening 214b, whereby the water may flow into a container or the like, such as in a similar manner as discussed above.

In the illustrated embodiment, the collapsible support structure 212 comprises a generally Z-shaped structure when expanded, with legs 218, 220 that are adjustable relative to a base structure 217 and an upper support structure 219. The base structure 217 has a plurality of elongated elements 217a-c joined together at their respective ends via a respective fixed 90 degree connector 224, while the legs 218, 220 are adjustably connected to the ends of the base structure 217 via respective adjustable connectors 226. Similarly, the upper support structure 219 has a plurality of elongated elements 219a-c joined together at their respective ends via a respective fixed 90 degree connector 224, while the legs 218, 220 are adjustably connected to the ends of the upper support structure 219 via respective adjustable connectors 226.

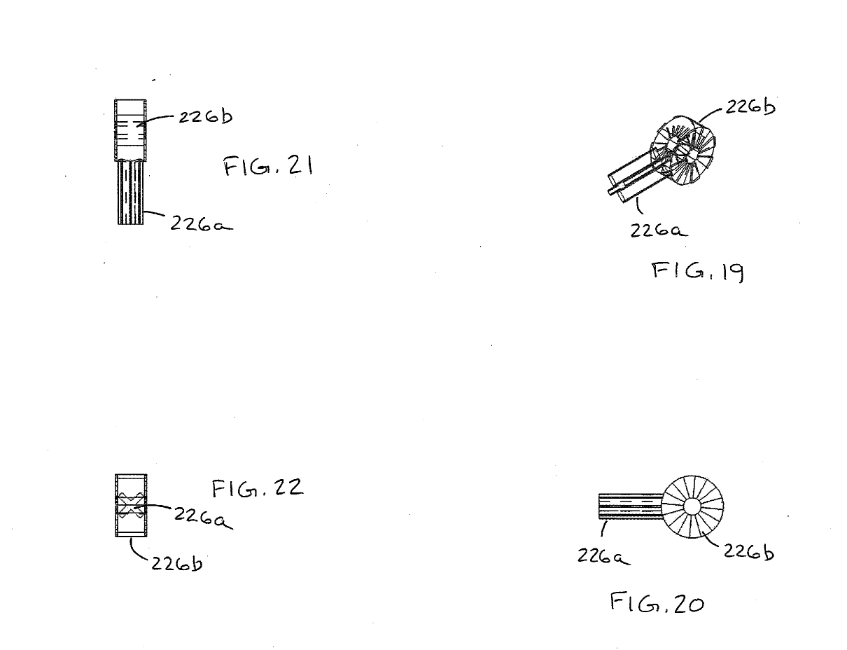

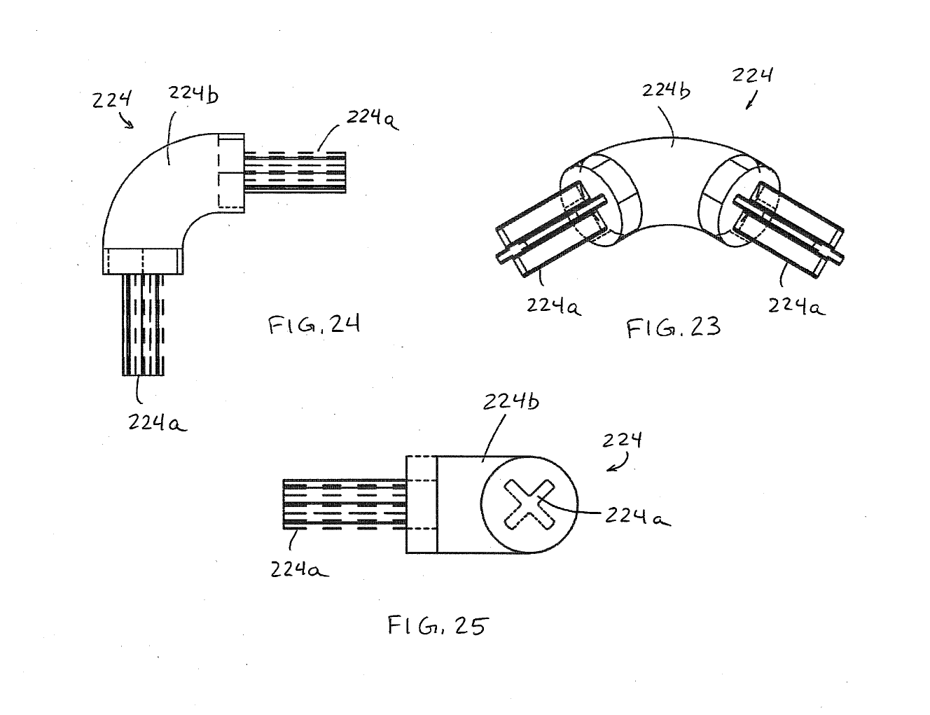

In the illustrated embodiment, the elongated elements 217a-c of the base structure 217 and the elongated elements 219a-c of the upper support structure 219 and the legs 218, 220 comprise hollow elongated rods, while the connectors 224, 226 have respective connecting portions 224a, 226a that are configured to be inserted into the ends of the elements or legs 217a-c, 219a-c, 218 and 220. For example, and as shown in FIGS. 22-24, the fixed connectors 224 have connecting portions 224a extending at about 90 degrees relative to one another from a central portion 224b for joining the base element 217b to elements 217a and 217c and for joining the upper element 219b to elements 219a and 219c. The funnel 214 is attached along the elements 219a-c and may span between the ends of the elements 219a, 219c or an additional rod or element may be disposed along the funnel 214 to provide additional support between the open end of the upper support structure 219.

In the illustrated embodiment, the adjustable connectors 226 comprise two connector portions that each have a connecting portion 226a and a circular adjustment portion 226b, whereby, when the adjustment portions 226b are clamped together (such as via a fastener or the like that may thread through the connectors) the mating surfaces of the adjustment portions 226b engage one another to limit rotation or adjustment of the connector 226, and when the adjustment portions 226b are sufficiently loosened relative to one another, the mating surfaces disengage or slide or slip relative to one another to allow for rotational adjustment of the connector. Thus, the legs 218, 220 are pivotally connected to the base structure 217 and the upper support structure 219 via the adjustable connectors 226 at the lower and upper ends of the legs. For example, the connector 226 shown in FIG. 14 may connect the upper end of the leg 218 to upper element 219a, while the connector shown in FIG. 17 may connect the lower end of the leg 218 to lower element 217a, and the connector shown in FIG. 15 may connect the upper end of the leg 220 to the upper element 219c, while the connector shown in FIG. 16 may connect the lower end of the leg 220 to the lower element 217c.

Thus, the legs may pivot about the axes of the adjustable connectors and relative to the base and support structures 217, 219 to raise or lower the upper support structure 219 relative to the base structure 217. The adjustable connectors allow for adjustment of the degree of opening or expansion of the funnel device and allow for maintaining the upper support structure generally parallel to the base structure irrespective of the degree of expansion of the funnel device.

Funnel 214 may comprise any suitable material, such as a flexible material, such as a fabric or plastic sheet material or the like, which may flex and/or fold as the funnel device 210 is collapsed to its non-use or storage state. When the funnel device 210 is unfolded to its use state, the upper end 214a of the funnel 214 may be generally taut between the upper support elements 219a-c so that the funnel 214 is held wide open to provide a large receiving area for receiving water that is dripping or flowing or falling from the leak in the overhead structure or ceiling or roof (or leaking pipe or conduit or the like). The funnel 214 may provide a four-sided funnel (such as shown) that has walls 214c that are tapered so that the walls taper or converge towards the lower end of the funnel, where the opening 214b is established for water to flow from the funnel and into the container. Optionally, a nozzle or tube may be provided at the opening 214b of the funnel, such that the tube may be at least partially received in the container to further limit or substantially preclude splashing or dripping of water onto the floor or support surface. The funnel 214 thus may be similar to funnel 14, discussed above, such that a detailed discussion of the funnels need not be repeated herein. Optionally, the funnel device 210 may include a perimeter skirt or cover 215 that may be part of the funnel 214 and may hang down from the upper support structure 219.

Therefore, the present invention provides a funnel system or funnel device that, when unfolded to its expanded or use state, provides a free standing funnel or funneling system that may be placed on a floor or support surface below a leak in a ceiling or roof or conduit or other overhead structure of a building, whereby water falling from the leak is collected or received at a larger upper opening of the funnel and is directed along the funnel to a narrower lower opening of the funnel and into a container placed at the floor or support surface beneath the funnel. The funnel device thus may collect or receive water over a large area to limit splashing and dripping of water onto the floor or support surface, and provides enhanced capturing of the leaking water in a container or the like. The container may be readily emptied or replaced when full and optionally, the funnel opening may be closed during the container emptying process. When not in use, the funnel device and system may be readily collapsed and stored.

Changes and modifications to the specifically described embodiments may be carried out without departing from the principles of the present invention, which is intended to be limited only by the scope of the appended claims as interpreted according to the principles of patent law including the doctrine of equivalents.

The embodiments of the invention in which an exclusive property is claimed are defined as follows:

1. A funnel assembly comprising:
a plurality of legs;
a funnel element having a larger opening and a smaller opening;
wherein said funnel element is attached at said legs and is collapsible and expandable between a use state, where said larger opening is substantially opened and said legs are arranged to support said funnel assembly in a free-standing manner, and a collapsed state, where said funnel and said legs are collapsed for storage; and
wherein, when in said use state, said funnel assembly is disposed at a floor or support surface and said larger opening is at an upper region of said funnel assembly and said smaller opening is at a lower region of said funnel and spaced from the floor or support surface.

2. The funnel assembly of claim 1, wherein said legs comprise at least three legs.

3. The funnel assembly of claim 2, wherein said legs comprise at least three sets of legs and wherein each set of legs comprises a pair of individual legs that are pivotally attached at a generally center region and pivot relative to one another to collapse and expand said funnel element.

4. The funnel assembly of claim 3, wherein an upper end of each of said individual legs is pivotally attached at an upper support element that is attached at an upper region of said funnel element and wherein a lower end of each of said individual legs is pivotally attached at a lower support element.

5. The funnel assembly of claim 1, wherein said legs comprise two legs pivotally and adjustably attached at each end to a respective one of a base support and an upper support.

6. The funnel assembly of claim 5, wherein, when said funnel assembly is in said use state, said legs are generally parallel to one another and said upper support and said base support are generally parallel to one another.

7. The funnel assembly of claim 1, wherein said funnel comprises a flexible material.

8. The funnel assembly of claim 1, wherein said funnel includes a plurality of creases along which said funnel folds when said funnel assembly is collapsed.

9. The funnel assembly of claim 1, wherein said funnel device is colored to provide an alert so that a person viewing said funnel assembly is warned of a potentially wet or hazardous floor.

10. The funnel assembly of claim 1, wherein said smaller opening is generally centered at said funnel assembly.

11. The funnel assembly of claim 1, wherein said smaller opening is off-centered and generally towards a side of said funnel assembly.

12. The funnel assembly of claim 1, wherein, when said funnel assembly is in said use state and disposed at a floor or support surface, said smaller opening is spaced from the floor or support surface to accommodate a container disposed at the floor or support surface and at least partially beneath said smaller opening.

13. A system for collecting fluid that is dripping from an overhead structure, said system comprising:
a funnel assembly comprising a plurality of legs and a funnel element having a larger opening and a smaller opening, wherein said funnel element is attached at said legs and is collapsible and expandable between a use state, where said larger opening is substantially opened and said legs are arranged to support said funnel assembly in a free-standing manner, and a collapsed state, where said funnel and said legs are collapsed for storage;
a container for receiving fluid from said smaller opening of said funnel;
wherein, when in said use state, said funnel assembly is disposed at a floor or support surface and said larger opening is at an upper region of said funnel assembly and said smaller opening is at a lower region of said funnel and spaced from the floor or support surface; and
wherein said container is disposed at said support surface and at least partially below said smaller opening of said funnel.

14. The system of claim 13, wherein said legs comprise at least three legs.

15. The system of claim 14, wherein said legs comprise at least three sets of legs and wherein each set of legs comprises a pair of individual legs that are pivotally attached at a generally center region and pivot relative to one another to collapse and expand said funnel element.

16. The system of claim 15, wherein an upper end of each of said individual legs is pivotally attached at an upper support element that is attached at an upper region of said funnel element and wherein a lower end of each of said individual legs is pivotally attached at a lower support element or foot.

17. The system of claim 13, wherein said legs comprise two legs pivotally and adjustably attached at each end to a respective one of a base support and an upper support.

18. The system of claim 17, wherein, when said funnel assembly is in said use state, said legs are generally parallel to one another and said upper support and said base support are generally parallel to one another.

19. The system of claim 13, wherein said funnel comprises a flexible material.

20. The system of claim 13, wherein said funnel includes a plurality of creases along which said funnel folds when said funnel assembly is collapsed.

21. The system of claim 13, wherein said funnel device is colored to provide an alert so that a person viewing said funnel assembly is warned of a potentially wet or hazardous floor.

22. A funnel assembly comprising:
a collapsible support structure;
a funnel element having a larger opening and a smaller opening;
wherein said funnel element is attached at an upper portion of said collapsible support structure and wherein said funnel element and said collapsible support structure are collapsible and expandable between a use state, where said larger opening is substantially opened and said collapsible support structure is arranged to support said funnel assembly in a free-standing manner, and a collapsed state, where said funnel and said collapsible support structure are collapsed for storage; and
wherein, when in said use state, said funnel assembly is disposed at a floor or support surface and said larger opening is at an upper region of said funnel assembly and said smaller opening is at a lower region of said funnel and spaced from the floor or support surface.

23. The funnel assembly of claim 22, wherein said collapsible support structure comprises a plurality of foldable legs.

24. The funnel assembly of claim 22, wherein said collapsible support structure comprises at least one coiled element.

25. The funnel assembly of claim 24, wherein said at least one coiled element is biased towards an extended state, where said at least one coiled element forms a generally cylindrical shape.

26. The funnel assembly of claim 25, wherein, when in said collapsed state, said at least one coiled element comprises a generally flat or disk-shaped structure.

27. The funnel assembly of claim 22, wherein said legs comprise two legs pivotally and adjustably attached at each end to a respective one of a base support and an upper support.

28. The funnel assembly of claim 27, wherein, when said funnel assembly is in said use state, said legs are generally parallel to one another and said upper support and said base support are generally parallel to one another.
